(19) United States
(12) Patent Application Publication
(10) Pub. No.: US 2008/0156890 A1
(43) Pub. Date: Jul. 3, 2008

(54) Fast Response Thermostatic Element, a Cartridge and Valve Provided with Said Element

(75) Inventors: Gerard Jean Andre Le Clanche, Draveil (FR); Christian Mace, Bruyeres Le Chatel (FR)

Correspondence Address: Ralph A. Dowell of DOWELL & DOWELL P.C., 2111 Eisenhower Ave, Suite 406, Alexandria, VA, 22314, US

(73) Assignee: Vernet, Ollainville (FR)

(21) Appl. No.: 11/793,353

(22) PCT Filed: Dec. 12, 2005
(86) PCT No.: PCT/FR2005/003180

§ 371 Date: Jul. 24, 2007

(30) Foreign Application Priority Data
Dec. 20, 2004 (FR) 04/13,576

(51) Int. Cl. G05D 23/02

(52) U.S. Cl. 236/101 R

(57) ABSTRACT

The inventive thermostatic element comprises a cup (1) containing a material (3) which is expendable and contractile according to the direction of the temperature variation thereof and a piston (5) which is movable with respect to the cup in the axial direction (X-X) thereof and is coupled to the expendable and contractile material in such a way that it is displaceable in the opposite direction according to the material expansion or contraction. In order to reduce the element response time in a simple and reliable manner, the cup (1) is embodied in one metal piece which internally delimits at least two distinct internal cavities (14A) for receiving at least one part of the expendable and contractile material (3).

The present invention relates to a thermostatic element of the type comprising a cup of elongated shape containing a material that can in particular expand and contract depending on the direction of variation of its temperature, and a piston that can move relative to the cup in the longitudinal direction of the latter and that is coupled to the expandable and contractile material in order to move in opposite directions depending on whether the material expands or contracts. The invention also relates to a thermostatic cartridge or faucet fitted with such an element.

Such thermostatic elements are used in particular in the field of regulating the temperature of a fluid originating from the mixture of two currents of fluid at different temperatures, the relative movement of the piston and of the cup being used to modify the proportion of the mixture of the two currents of fluid. This is particularly the case in mixer faucet cartridges and in mixer faucets.

For a large number of applications in this field, the response of the thermostatic element must be extremely rapid, that is to say that the change of temperature of the medium in which the cup lies causes a corresponding movement of the piston in a very short time. This is particularly the case for thermostatic elements immersed in a current of water supplying a sanitary installation, an application for which, when an ideal temperature has been selected, a temperature drop of only three or four degrees is extremely unpleasant, and an increase of a few degrees may be the cause of scalding.

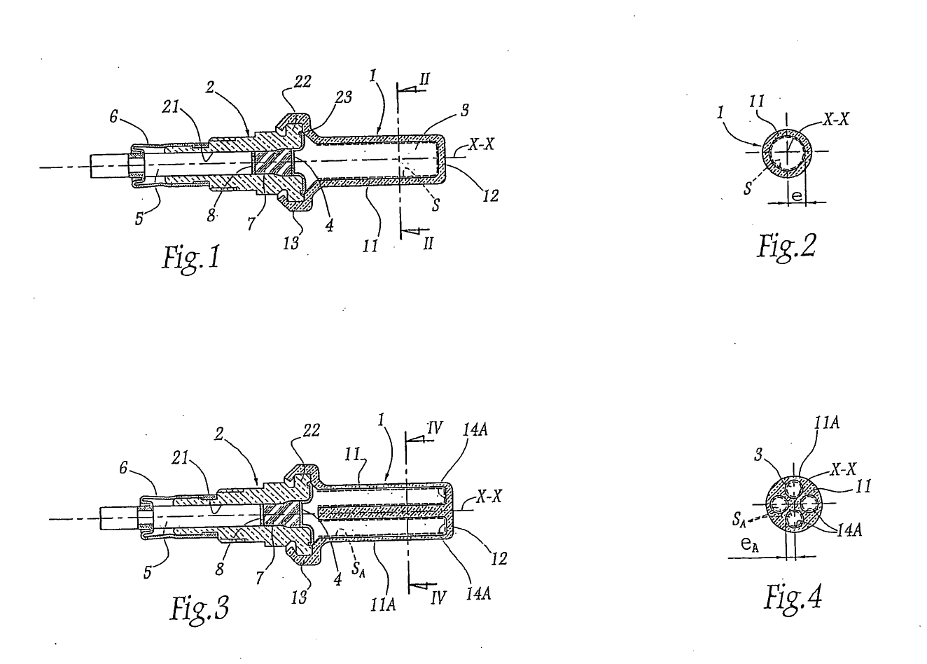

The thermostatic elements conventionally used in this type of application comprise, for example according to FIGS. 1 and 2, a metal cup 1 having an unsupported tubular portion 11 having a generally cylindrical shape with a circular base and a longitudinal axis X-X. A bottom end 12 closes this portion 11 while the opposite end spreads out to be connected to a collar 13. A sheath 2, having a shape of revolution with a central channel 21, comprises a base 22 housed in the collar of the cup so that, except for the base 22, the sheath 2 extends outside the cup in the direction opposite to the cylindrical portion 11 of the latter, and coaxially. The collar 13 is swaged around the base 22.

The tubular portion 11 of the cup is filled with a mass of material that is extremely expandable and contractile depending on the temperature variations, particularly around a functional temperature, here a mass of wax 3. The base 22 of the sheath comprises in its face that is opposite to this mass of wax, an annular housing 23 in which is anchored the periphery of a diaphragm 4 that is disk-shaped and elastically deformable, blocking the central channel 21 of the sheath on the side of the cup 1. Inside the channel 21 of the sheath is housed a piston 5 subjected to the movements of the central region of the diaphragm, the end of this piston opposite to the diaphragm protruding more or less from the sheath depending on the volume occupied by the wax, hence according to the temperature of the latter. A tubular protective bellows 6 surrounds a portion of the sheath 2 and of the piston 5, its ends being immobilized in grooves made in the periphery of these two parts. This bellows 6, in the shape of a flexible unrolling membrane, follows the movements of. the piston without plastic deformation. The piston 5 is subjected to the movements of the central region of the diaphragm 4 by means of a pad 7 made of deformable elastomer in contact with the surface of the diaphragm opposite to the mass of wax and a shim 8 made of polymer such as PTFE inserted between the pad and the piston and adjusted in the channel 21 to prevent the elastomer of the pad from creeping around the piston.

DE-A-30 13 386, DE-A-34 13 466 and GB-A-1 385 372 describe thermostatic elements whose cup is similar to that of FIGS. 1 and 2, that is to say whose cup internally delimits a single chamber for storing a heat-expandable wax.

The general design of these thermostatic elements is well suited to the use of a wax whose dilation coefficient is very great relative to that of the common fluids (approximately 10 to 20 times greater) and therefore capable of causing a very ample movement of the piston. Unfortunately, these waxes have a very low thermal conductivity (approximately 1000 times less than that of copper), and therefore the temperature of the entire mass of the wax reflects only imperfectly and with a great delay that of the fluid in which the cup is bathed. For this reason, the wax is usually “filled” with a powder of a material having a good thermal conductivity, for example a copper powder with an appropriate particle size. For simplification, in what follows, “wax” will be used to mean filled materials and unfilled mixtures and single-component waxes. However, all these artifices are insufficient to obtain a rapid response thermostatic element that can be used without particular precaution in a sanitary installation.

In particular to remedy this disadvantage, it has been proposed, particularly in FR-A-2 775 780 and EP-A-0 967 536, to fit, inside the cup of the thermostatic element, a metal insert in contact with the peripheral wall of the cup. This insert is for example positioned in the cup 1 of FIGS. 1 and 2, in contact with the portion 11 and/or the bottom 12. In this way, the heat of the peripheral wall of the cup is transmitted more rapidly to the internal metal insert than to the wax, the latter then being heated by the insert in addition to its heating by the peripheral wall of the cup. However, installing such a fitted insert is a complex operation that requires particular attention to ensure a sufficient and stable contact between the insert and the external wall of the cup to effectively transmit the heat from the cup to the insert.

The object of the present invention is to provide an alternative solution to the presence of a fitted insert as mentioned above and to propose a rapid response thermostatic element that is more reliable and easier to manufacture.

Accordingly, the subject of the invention is a thermostatic element, comprising a cup containing a material that can expand and contract depending on the direction of variation of its temperature, and a piston that can move relative to the cup in an axial direction of the latter and that is coupled to the expandable and contractile material in order to move in opposite directions depending on whether the material expands or contracts, characterized in that the cup is made in a single metal piece in which at least two internal cavities are delimited for receiving at least one portion of the expandable and contractile material.

The use of the one-piece metal part to receive the expandable and contractile material makes it easier to obtain the thermostatic element since no operation for installing a fitted insert and for fixedly attaching this insert is necessary. In addition, the walls of the cup delimiting the cavities are connected to the external face of the cup by a continuity of metal material which provides an optimal thermal conduction between the outside of the cup in contact with the ambient medium and the material stored in the cavities. In addition, in use, the behavior in service of the thermostatic element according to the invention is better than that of a thermostatic element with a fitted insert, the zones of contact between this insert and the peripheral wall of the cup risking, in the long term, being damaged while, with the element according to the invention, the metal material forming the cup and delimiting the cavities is acted upon thermally in a single piece.

Relative to the conventional thermostatic element of FIGS. 1 and 2 and to those envisaged in the aforementioned documents DE-A-30 13 386, DE-A-34 13 466 and GB-A-1 385 372, the thermal flux transmitted, via the one-piece metal cup, from the outside of the element according to the invention to the expandable and contractile material distributed in the cavities, is considerably increased, significantly reducing the response time of the thermostatic element according to the invention.

According to other features of this thermostatic element, taken in isolation or according to all the technically possible combinations:
one and the same cross-sectional plane to the thermostatic element passes through the cavities;
in the aforementioned cross-sectional plane, the cavities are distributed about the axis of the cup;
each cavity is blind and opens on the side of the cup turned toward the piston;
each cavity extends lengthwise in a direction substantially parallel to the axial direction of the cup;
each cavity has a generally cylindrical shape with a circular base;
the external lateral face of the cup is essentially cylindrical in a direction substantially parallel to the axial direction of the cup;
the essentially cylindrical shape of the external lateral face of the cup has a circular base;
the essentially cylindrical shape of the external lateral face of the cup is adjusted to the shape of the cavities;
at least 80% of the expandable and contractile material is stored in the cavities;
the cup is furnished with external ribs protruding outward.

A further subject of the invention is a thermostatic cartridge or a thermostatic faucet, furnished with a thermostatic element as defined above.

The invention will be better understood on reading the following description given only as an example and made with reference to the drawings in which:

FIG. 1 is a longitudinal section of a known thermostatic element that has been described above;

FIG. 2 is a cross section of the thermostatic element of FIG. 1 along the plane II-II of this figure;

FIGS. 3, 5, 7 and 9 are views similar to FIG. 1, of respectively four different embodiments of a thermostatic element according to the invention; and

FIGS. 4, 6, 8 and 10 are respectively cross sections of the thermostatic elements of FIGS. 3, 5, 7 and 9, respectively along the planes IV-IV, VI-VI, VIII-VIII and IX-IX of these figures.

The known thermostatic element of FIGS. 1 and 2 having been described above, it will not be described in detail here again. For convenience, the members of the thermostatic elements according to the invention that correspond to members of the known element bear the same reference numbers.

Like the known thermostatic element, the thermostatic elements represented in FIGS. 3 to 10 are designed to be fitted to a faucet cartridge or a thermostatic faucet and comprise:
a metal cup 1 extending along a central axis X-X, having an unsupported portion 11 of elongated shape filled with a mass of essentially expandable and contractile material 3, such as wax, and furnished, at one end, with a closed transverse bottom wall 12 while the opposite end spreads out to be connected to a collar 13, and
a sheath 2 having a shape of revolution with a central channel 21 and a base 22 housed in the collar of the cup, the collar 13 being swaged around the base 22, and the cup and the sheath extending coaxially along the axis X-X in opposite directions.

The thermostatic elements of FIGS. 3 to 10 also comprise an elastically deformable diaphragm 4, a piston 5 subjected to the movement of the central region of this diaphragm by means of a pad 7, with interposition of a shim 8, and a protective bellows 6. These components will not be described again in detail here since they have been explained before with respect to FIGS. 1 and 2.

Turning now to the differences relative to the element of FIGS. 1 and 2, and considering in greater detail the embodiment of FIGS. 3 and 4, the cup 1 is made in a single piece that internally delimits four distinct cylindrical cavities 14A, inside which is stored the majority of the wax 3, while externally, the cup has an essentially cylindrical lateral face 11A with a circular base, centered on the axis X-X. Each cylindrical cavity 14A extends lengthwise in a direction substantially parallel to the axis X-X.

Laterally, each cavity is closed by a wall consisting of the unsupported portion 11 of the metal cup 1. In addition, each cavity 14A is closed, at one of its longitudinal ends, by the bottom wall 12 of the cup while at their opposite end, the cavities 14A open onto the diaphragm 4, axially at the collar 13.

Advantageously, more than 80%, even 90%, of the wax 3 is stored in the cavities 14A.

The cavities 14A are for example made in a solid metal barrel designed to form the cup 1, after finishing, by machining, drop forging or similar operations.

In operation, when the thermostatic element of FIGS. 3 and 4 moves from a first state called “cold”, in which its wax 3 has a uniform temperature equal to the temperature θ₀ of the external medium, such as mixed water exiting from a mixer faucet cartridge, to a heated state resulting from a sudden increase in the temperature of the external medium to a value θ₁, a thermal flux occurs from the external medium to the cup 1 and from the cup 1 to the heat-expandable wax 3, until, after a period Δ, the thermostatic element, in particular its wax 3, reaches a uniform temperature equal to the new hot temperature θ₁ of the external medium. The heat travels very rapidly throughout the metal of the cup 1, particularly up to the walls of the cup delimiting the internal cavities 14A. The temperature of the wax 3 having increased from θ₀ to θ₁, it expands and, since the cup 1/sheath 2 assembly is not deformable, the wax 3 deforms, by expanding, the diaphragm 4 which, in its turn, deforms the pad 7, the latter moving the shim 8 and the piston 5 in the channel 21 of the sheath. Therefore, a sudden increase in the temperature of the external medium causes the piston 5 to move out of the sheath 2, after the period Δ, called in practice the “response time”.

The greater the thermal flux toward the heat-expandable wax 3, the shorter this response time. Since the material of the cup 1 has a much better coefficient of thermal conduction than that of the wax, the aforementioned thermal flux depends essentially on the difference in the temperatures θ₀ and θ₁, on the area of contact between the wax 3 and the cup and on the maximum distance, in cross section, between the cup and any particle of the wax. More precisely, the thermal flux increases with the difference θ₀−θ₁ and with the value of the area of contact while it reduces with the maximum cup/wax distance. In FIGS. 1 and 2, the area of contact, indicated in dashed lines for better visibility, is marked S and the maximum cup/wax distance is marked e. In FIGS. 3 and 4, the area of contact to be considered corresponds to the sum of the four individual areas, marked S_{A}, of contact between the walls delimiting the four cavities 14A and the wax, and the maximum cup/wax distance is marked e_{A}, it being noted that this distance is the same at each cavity 14A.

With the thermostatic element of FIGS. 3 and 4, the sum of the areas of contact S_{A} is greater than the area of contact S associated with the conventional thermostatic element of FIGS. 1 and 2, while the distance e_{A} is shorter than the distance e, and this for an identical volume of wax and length of cup. The response time is therefore considerably shorter with the thermostatic element of FIGS. 3 and 4 than with the element of FIGS. 1 and 2.

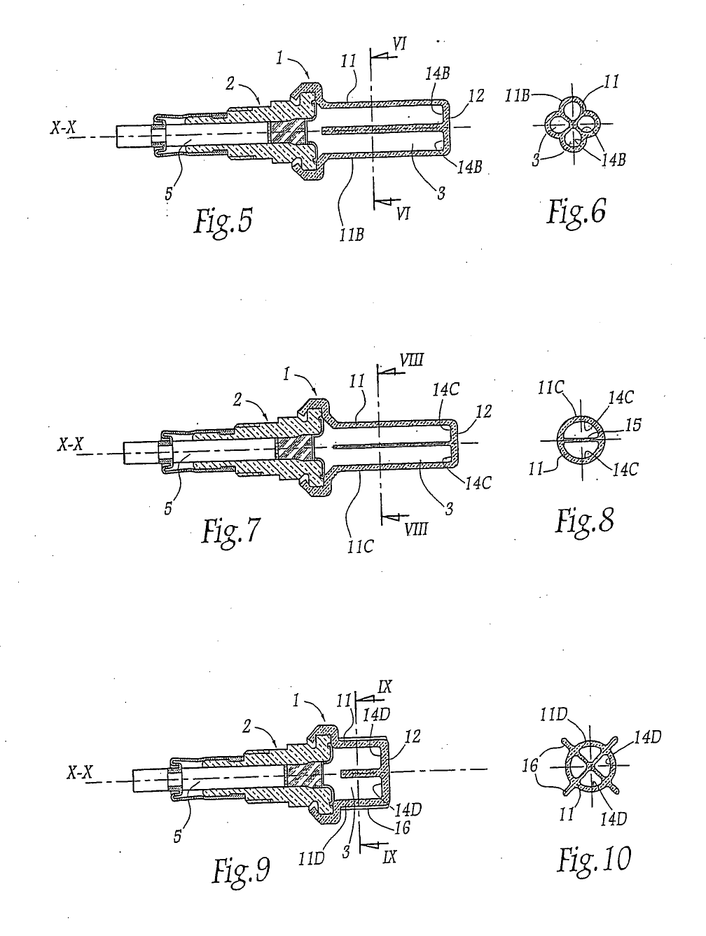

In the embodiment of FIGS. 5 and 6, the metal cup 1 of the thermostatic element internally delimits, as in FIGS. 3 and 4, four cylindrical internal cavities 14B for receiving the majority of the wax 3. Unlike the cavities 14A, the cross section of the cavities 14B is not strictly circular, but forms a droplet pattern, whose point is directed toward the axis X-X. Unlike the external lateral face 11A of the cup of FIGS. 3 and 4, the external lateral face 11B of the cup 1 of FIGS. 5 and 6 is adjusted to the shape of the cavities 14B, that is to say in cross section, it has a four-lobed contour generally in the shape of a four-leafed clover. In other words, along the periphery of the cup, the thickness of metal between the face 11B and the opposite wall delimiting the corresponding cavity 14A is substantially constant.

In the embodiment of FIGS. 7 and 8, the external lateral face 11C of the cup 1 is generally cylindrical with a circular base, as in FIGS. 3 and 4. On the other hand, unlike the embodiments of FIGS. 3 to 6, the one-piece metal part forming the cup 1 of FIGS. 7 and 8 delimits only two internal cavities 14C for storing the wax 3. These two cavities are separated from one another by a flat partition 15 that extends in a diametral plane of the cup 1, while being made in one piece with and of the same material as the rest of the cup both in the unsupported portion 11, in this instance tubular, and the bottom wall 12.

In the embodiment of FIGS. 9 and 10, the cup 1, with an unsupported portion that is externally cylindrical with a circular base, internally delimits four cavities 14D for storing the wax 3. In cross section, these. cavities do not have a circular or droplet-shaped contour as in FIGS. 4 and 6, but a contour corresponding to a portion of the circular section of the unsupported portion 11 of the cup 1. Specifically, the cavities 14D are delimited, in addition to the tubular wall of the portion 11 and to the bottom wall 12, by two partitions internal to the cup, similar to the partition 15 of FIGS. 7 and 8 and made in one piece with and of the same material as the rest of the cup, which extend respectively along diametral planes of this cup, perpendicular to one another. In addition, the unsupported portion 11 of the cup is furnished with ribs 16 that extend in protrusion outward from the lateral face 11D and that are designed to be in contact with the medium external to the thermostatic element.

The embodiment of FIGS. 9 and 10 furthermore differs from the preceding embodiments in that its cup 1 is shorter along the axis X-X. As an example, the length of this cup, that is to say its dimension taken along the axis X-X, is substantially equal to its diameter.

Various changes and variants to the thermostatic elements described above can naturally be envisaged. In particular, it is possible to provide embodiments having different dimensions, appropriate to the specific application of the thermostatic element, and very diverse cavity shapes. Similarly, various geometries of cups can be envisaged, with cups whose lateral external face has more flats, depressions and/or domes or whose length is shorter than its diameter.

1. A thermostatic element, comprising a cup (1) containing a material (3) that can expand and contract depending on the direction of variation of its temperature, and a piston (5) that can move relative to the cup in an axial direction (X-X) of the latter and that is coupled to the expandable and contractile material in order to move in opposite directions depending on whether the material expands or contracts, characterized in that the cup (1) is made in a single metal piece that internally delimits at least two distinct internal cavities (14A; 14B; 14C; 14D) for receiving at least one portion of the expandable and contractile material (3).

2. The thermostatic element as claimed in claim 1, characterized in that one and the same cross sectional plane (FIGS. 4; 6; 8; 10) to the thermostatic element passes through the cavities (14A; 14B; 14C; 14D).

3. The thermostatic element as claimed in claim 1, characterized in that each cavity (14A; 14B; 14C; 14D) is blind and opens on the side of the cup (1) turned toward the piston (5).

4. The thermostatic element as claimed in claim 1, characterized in that each cavity (14A; 14B; 14C; 14D) is blind and opens on the same side of the cup (1) turned toward the piston (5).

5. The thermostatic element as claimed in claim 1, characterized in that each cavity (14A; 14B; 140; 14D) extends lengthwise in a direction substantially parallel to the axial direction (X-X) of the cup (1).

6. The thermostatic element as claimed in claim 1, characterized in that each cavity (14A) has a generally cylindrical shape with a circular base.

7. The thermostatic element as claimed in claim 1, characterized in that the external lateral face (11A; I1B; 11C; 11D) of the cup (1) is essentially cylindrical in a direction substantially parallel to the axial direction (X-X) of the cup.

8. The thermostatic element as claimed in claim 7, characterized in that the essentially cylindrical shape of the external lateral face (11A; 11C; IID) of the cup (1) has a circular base.

9. The thermostatic element as claimed in claim 7, characterized in that the essentially cylindrical shape of the external lateral face (I1B) of the cup (1) is adjusted to the shape of the cavities (14B).

10. The thermostatic element as claimed in claim 1, characterized in that at least 80% of the expandable and contractile material (3) is stored in the cavities (14A; 14B; 30 14C; 14D).

11. The thermostatic element as claimed in claimed, characterized in that the cup (1) is furnished with external ribs (16) protruding outward.

12. A thermostatic cartridge or thermostatic faucet fitted with a thermostatic element as claimed in claim 1.
